(19) United States
(12) Patent Application Publication
(10) Pub. No.: US 2020/0029570 A1
(43) Pub. Date: Jan. 30, 2020

(54) MICROORGANISM-PRODUCED COMPOSITIONS HAVING STIMULATORY ACTIVITY ON PLANTS

(71) Applicants: IDEN BIOTECHNOLOGY, S.L., Cordovilla (ES); CONSEJO SUPERIOR DE INVESTIGACIONES CIENTÍFICAS, Madrid (ES); UNIVERSIDAD PÚBLICA DE NAVARRA, Pamplona (ES)

(72) Inventors: Carol Paola BEJARANO TOVAR, Cordovilla (ES); Pedro Roberto MOLINA GUEVARA, Cordovilla (ES); Nerea FERNÁNDEZ ORTIZ DE JÓCANO, Cordovilla (ES); Xana Melissa BELASTEGUI MACADAM, Cordovilla (ES); Abdellatif BAHAJI, Mutilva (ES); Angela Maria SÁNCHEZ LÓPEZ, Mutilva (ES); Miren Edurne BAROJA FERNÁNDEZ, Mutilva (ES); Francisco José MUÑOZ PÉREZ, Mutilva (ES); Javier POZUETA ROMERO, Mutilva (ES)

(21) Appl. No.: 16/090,789

(22) PCT Filed: Apr. 3, 2017
(86) PCT No.: PCT/EP2017/057847

§ 371 Date: Oct. 2, 2018

(30) Foreign Application Priority Data
Apr. 4, 2016 (EP) 16382146.5

(51) Int. Cl. A01N 63/00; A01N 63/04; A01N 63/02

(52) U.S. Cl. CPC A01N 63/00; A01N 63/02; A01N 63/04

(57) ABSTRACT

It relates to compositions produced by microorganism cell cultures, including microorganism-free compositions as well as compositions comprising inactivated microorganisms. It also relates to methods for obtaining the compositions produced by microorganism cell cultures and to agricultural compositions comprising them. It also relates to the use of the compositions of the invention as plant growth promoting agents and to methods for promoting stimulatory activity on plants comprising administering to the plant with these compositions.

This application claims the benefit of European Patent Application EP16382146.5 filed on Apr. 4, 2016.

The invention relates to compositions produced by microorganism cell cultures that have stimulatory activity on plants. It also relates to methods for their preparation, to agricultural compositions comprising them, and to their use in methods for promoting plant growth and yield.

### BACKGROUND ART

In order to increase the agricultural productivity in the fields, in particular of plants and crops, the application of synthetic chemical compositions, such as fertilizers or plant growth regulators, or genetic engineering methods have been traditionally used to improve plant growth, and the quality and yield of plant-related products.

However, these methods may be associated to several problems in the long-term or are very expensive. For example, the over-application of external chemicals might lead to environmental contamination and to the deterioration of the conditions of the soil in which plants grow, this often requiring the application of additional synthetic substances in order to improve soil conditions.

Plants' growth and development are influenced by microorganisms occurring either aboveground in the phyllosphere, underground in the rhizosphere and/or in the endosphere inside the vascular transport system and apoplastic space. Microbes synthesize a multitude of substances including carbohydrates, proteins, lipids, amino acids, hormones, etc., which may act directly or indirectly to activate plant immunity or regulate plant growth and morphogenesis.

Microbes also synthesize and emit many volatile compounds (VOCs, VCs) with molecular masses less than 300 Da, low polarity, and a high vapor pressure that can diffuse far from their point of origin and migrate in soil and aerial environments as well as through porous wood materials.

Hence, VOCs may play potentially important roles as semiochemicals in interspecies communication, participating in countless interactions among plants and microorganisms, both below and above ground.

VOCs emitted by some bacteria and fungi can exert inhibitory effects on plant growth. Conversely, depending on microbial culture conditions, volatile emissions from some beneficial rhizosphere bacteria and fungi can promote plant growth.

For example Ryu et al. (PNAS 2003, Vol. 100(8), pp. 4927-4932) describe the effects on plant growth by exposure of Arabidopsis thaliana seedlings to airborne chemicals released from six growth-promoting bacterial strains: Pseudomonas fluorescens 89B-61, Bacillus pumilus T4, B. pasteurii C-9, B. subtilis GB03, B. amyloliquefaciens IN937a, Serratia marcescens 90-166, and Enterobacter cloacae JM22. However, the method described in this document is not suitable for large scale production.

Furthermore, WO2011135121 discloses that VOCs from a number of microorganisms ranging from Gram-negative and Gram-positive bacteria to different fungi promote growth and flowering of various plant species. According to this document not all the volatiles produced by the microorganisms are capable of influencing the increase in biomass. The microorganisms cited by this document include the fungal species Penicillium charlesii, Penicillium aurantiogriseum, or Alternaria alternata, the yeast species Saccharomyces cerevisiae, and the bacterial species Bacillus subtilis, Salmonella enterica, Escherichia coli, Agrobacterium tumefaciens or Pseudomonas syringae. According to this document, the exposure to the VOCs produced by these microorganisms also promotes the accumulation of exceptionally high levels of starch in leaves of mono- and dicotyledonous plants. However, for some applications it may be desirable to promote plant growth without changing starch levels. Besides, this document provides only little information regarding the preparation of compositions suitable for large scale production or for application in open fields.

Thus, there is a need of developing alternative agricultural compositions and strategies for increasing yield of plants, in particular, field crops or horticultural crops in a sustainable and environmentally benign manner.

### SUMMARY OF THE INVENTION

The inventors found and developed new compositions produced by microorganism cell cultures that have stimulatory activity on plants, in particular crops including field crops and horticultural crops, without being toxic for the plants and without negatively affecting their quality characteristics. As it is shown in the examples of the present invention, these compositions when contacted with the plants promote plant growth. In particular, in the treated plants it is observed, for example, an increase in the net yield (acceptable raw material), commercial yield, early plant growth, early plant development, an increase in shoot number, an increase in leaves fresh weight (FVV), in shoot length, in shoot system fresh weight (FVV)/dry weight(DVV), in root length, in aerial part fresh weight (FW)/dry weight (DW), ear fresh weight (FW)/dry weight (DW), seed fresh weight (FVV)/dry weight (DW), in root fresh weight (FW)/dry weight (DVV), in the number of ears and in the chlorophyll and protein content. With regard to the fruits, an increase in the fruit size and quantity (specific weight, commercial weight) without negative effects in fruit firmness, texture, pH or brix content was also observed, as well as a diminished amount of overripe fruits. The examples also demonstrate that the treated plants showed improved emergence rate and resistance to abiotic stress.

Besides, in some embodiments, plant growth is achieved without changing starch levels, which may be beneficial for some applications. In some cases, the change in starch levels might be followed by a change in protein content, which in some cases could not be of commercial interest, for example in the production of grain for feed.

Additionally, the compositions produced by microorganism cell cultures disclosed herein can be obtained by easily scalable processes, which make them suitable for industrial production, as such or formulated into agricultural compositions.

The compositions of the invention produced by microorganism cell cultures encompass microorganism-free compositions, which do not comprise microorganisms or fragments thereof, and compositions comprising inactivated microorganisms. These compositions are obtainable by culturing a microorganism cell culture in specific growth media, and therefore, they are not present in nature.

Thus, a first aspect of the invention relates to a microorganism-free composition obtainable by a method comprising the following steps:

(a) growing a microorganism in an appropriate culture medium; and

(b) removing the microorganism from the culture medium of step a) when the microorganism growth has started the logaritmic growth phase, to obtain the microorganism-free composition,

wherein the microorganism is selected from the group consisting of: strain CECT 20912 of Alternaria alternata or a mutant thereof, strain CECT 2662 of Alternaria alternata or a mutant thereof, strain CECT 20560 of Alternaria alternata or a mutant thereof, strain CECT 20923 of Alternaria alternata or a mutant thereof, strain CECT 20943 of Alternaria alternata or a mutant thereof, strain DSM-1102 of Alternaria alternata or a mutant thereof, strain DSM-12633 of Alternaria alternata or a mutant thereof, strain DSM-62006 of Alternaria alternata or a mutant thereof, strain DSM-62010 of Alternaria alternata or a mutant thereof, strain MTCC 1779 of Alternaria alternata or a mutant thereof, strain MTCC 3793 of Alternaria alternata or a mutant thereof, strain MTCC 6572 of Alternaria alternata or a mutant thereof, strain MTCC 7202 of Alternaria alternata or a mutant thereof, strain MTCC 7959 of Alternaria alternata or a mutant thereof, strain MTCC 8459 of Alternaria alternata or a mutant thereof, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, Penicillium charlesii, Aspergillus awamori, Aspergillus brasiliensis, Colletotrichum gloeosporioides, Ophiostoma ips, Paecilomyces clavisporus, Penicillium digitatum, Pichia fermentans var. fermentans, Saccharomyces cerevisiae, Verticillium dahliae, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Pseudomonas fluorescens, Pseudomonas syringae, Salmonella enterica, Serratia liquefaciens, Serratia odorifera, and Stenotrophomonas maltophilia.

A second aspect of the invention relates to a composition comprising an inactivated microorganism obtainable by a method comprising the following steps:

(a) growing a microorganism cell culture in an appropriate medium; and

(b) inactivating the microorganism in the culture medium of step a) when the microorganism growth has started the logaritmic growth phase, to obtain the composition comprising an inactivated microorganism, wherein the microorganism is selected from the species consisting of Alternaria alternata, Aspergillus awamori, Aspergillus brasiliensis, Beauveria bassiana, Botrytis aclada, Colletotrichum gloeosporioides, Fusarium oxysporum, Ophiostoma ips, Paecilomyces clavisporus, Penicillium charlesii, Penicillium chrysogenum, Penicillium digitatum, Penicillium aurantiogriseum, Pichia fermentans var. fermentans, Saccharomyces cerevisiae, Trichoderma harzianum, Verticillium dahliae, Wickerhamomyces anomalus, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Escherichia coli, Pseudomonas fluorescens, Pseudomonas syringae, Salmonella enterica, Serratia liquefaciens, Serratia odorifera, and Stenotrophomonas maltophilia.

The compositions produced by microorganism cell cultures mentioned above may be formulated in the form of agricultural compositions further comprising additional components. Thus, a third aspect of the invention relates to an agricultural composition comprising the microorganism-free compositions or the compositions comprising an inactivated microorganism as defined above, together with one or more agriculturally acceptable carriers.

Another aspect of the invention relates to a method for obtaining a microorganism-free composition as defined above, which comprises the following steps:

(a) growing a microorganism in an appropriate culture medium; and

(b) removing the microorganism from the microorganism culture medium of step a) when the microorganism growth has started the logaritmic growth phase, to obtain the microorganism-free composition.

Another aspect of the invention relates to method for obtaining a composition comprising an inactivated microorganism as defined above, which comprises the following steps:

(a) growing a microorganism cell culture in an appropriate medium; and

(b) inactivating the microorganism in the culture medium of step a) when the microorganism growth has started the logaritmic growth phase, to obtain the composition comprising an inactivated microorganism.

As previously mentioned, the compositions of the invention including the compositions produced by microorganism cell cultures as well as the agricultural compositions containing them are useful in plant growth and related features. Thus, another aspect of the invention relates to the use of any composition as defined above as plant growth promoting agent.

Additionally, another aspect of the invention relates to a method for promoting stimulatory activity on a plant comprising administering to the plant an effective amount of any composition as defined above.

In a final aspect, the present invention provides an Alternaria alternata strain deposited in the Spanish Type Culture Collection (CECT) with the access number CECT 20912, or a mutant thereof.

The strain of Alternaria alternata of the invention was deposited by the applicant, according to the Budapest Treaty, on Jun. 11, 2014, in the Spanish Type Culture Collection (CECT), located at the University of Valencia, Edificio de investigación, Campus de Burjassot, 46100 Burjassot, Valencia, Spain. The strain was given the access number CECT 20912 after the strain was considered both viable and pure.

The invention also relates to mutants of the strain CECT 20912 of Alternaria alternata. By the term “mutants” is understood fungi that are obtained using, as starting material, the strain CECT 20912 of the invention, and that are characterised in maintaining the properties of said deposited strain. A “mutant” of CECT 20912 of Alternaria alternata is also understood according to the invention as a “variant” of CECT 20912 of Alternaria alternata. The skilled in the art will understand that mutants can be obtained routinely, for example by spontaneous mutagenesis or directed mutation, using the strain of the invention as starting material. Methods for obtaining mutants of a specific microbial strain are known in the art. An example can be found in Sambrook, J. and Russell, D. W. “Molecular Cloning: A Laboratory Manual”, Chapter 13, “Mutagenesis”, Cold Spring Harbor, 3rd Ed, 2001.

### BRIEF DESCRIPTION OF THE DRAWINGS

FIG. 1 shows the effect of a microorganism-free composition produced by a Penicillium aurantiogriseum cell culture in the shoot length of tomato plants compared to control plants.

FIG. 2 shows the effect of a microorganism-free composition produced by Escherichia coli cell culture in the root length of tomato plants compared to control plants.

FIG. 3 shows the effect of a microorganism-free composition produced by Alternaria alternata cell culture in the root length of tomato plants in soil substrate compared to control plants.

FIG. 4 shows the effect of a microorganism-free composition produced by Alternaria alternata cell culture in the net yield (acceptable raw material) obtained from tomato plants grown in field conditions and treated with different treatments (T8-T16) compared to control plants (T1).

FIG. 5 shows the effect of a microorganism-free composition produced by Alternaria alternata cell culture in the average net yield (acceptable raw material) obtained from tomato plants grown in field conditions and treated with different treatments (1, 2 and 5) compared to control plants (11).

FIG. 6 shows the effect of VOCs emitted by phylogenetically diverse microorganisms in fresh weight (FVV) (a) and time of floral bud appearance (b) of Arabidopsis plants cultured in the absence or continuous presence of adjacent cultures of the indicated microorganisms for one week.

FIG. 7 shows the effects of VOCs emitted by A.alternata in fresh weight (FVV) in soil-grown Arabidopsis plants (a) and in plant height (b, and c) in soil-grown maize and pepper plants, respectively. All treated plants were cultured in the absence or continuous presence of adjacent cultures of A. alternata for indicated times. The effect of the treated plants (+VCs) is compared to the control (−VCs).

FIG. 8 shows root architecture determinations of Arabidopsis plants subjected to fungal volatiles from Alternaria alternata, Penicillium aurantiogriseum and Penicillium chrysogenum for 7 days compared to control plants.

### DETAILED DESCRIPTION OF THE INVENTION

All terms as used herein in this application, unless otherwise stated, shall be understood in their ordinary meaning as known in the art. Other more specific definitions for certain terms as used in the present application are as set forth below and are intended to apply uniformly through-out the specification and claims unless an otherwise expressly set out definition provides a broader definition.

As mentioned above, the invention relates to compositions produced by microorganism cell cultures in which the microorganism has grown and metabolized. Microorganisms considered as pathogens for plants may also be used for producing the compositions of the invention as long as they give rise to compositions that have stimulatory activity on plants. As the microorganism as such may be harmful for the plant, it is removed or inactivated. When the microorganism is removed from the culture medium in which the microorganism has been grown, e.g., by centrifugation and/or filtration, then a composition is obtained which is microorganism-free. When alternatively, the microorganism is not removed, or not completely removed, from the culture medium in which it has been grown, but it is inactivated, e.g. by lysis (i.e. the inactivated microorganism or parts of it are present in the medium), then a composition comprising an inactivated microorganism is obtained. In both cases, these compositions are obtainable by culturing a microorganism in specific growth media and culturing conditions as disclosed herein.

The terms “microorganism-free composition” or “composition comprising an inactivated microorganism” obtainable by the process are used herein for defining these compositions by its preparation process and refers to the products that can be obtained through the preparation process which comprise the indicated steps as herein defined. For the purposes of the invention, the expressions “obtainable”, “obtained” and similar equivalent expressions are used interchangeably and, in any case, the expression “obtainable” encompasses the expression “obtained”.

For the purposes of the invention, the term “microorganism” refers to unicellular, multicellular and acellular organisms such as bacteria and fungi, and the like.

The term “microorganism-free composition” as used herein refers to a composition produced by a microorganism cell culture, which is obtained after removing the microorganism that has been used in the process of the invention, in particular in step a) of the process, from the culture medium. The microorganism-free composition lacks any viable cells, mycelia, or endospores, which, as mentioned above, could be harmful for the plant. It may however contain other non-pathogenic microorganisms that are not toxic for the plants.

The term “composition comprising an inactivated microorganism” as used herein refers to a composition produced by microorganism cell cultures, which is obtained after inactivating the microorganism in the culture medium in which the microorganism has been grown. The term “inactivated microorganism” refers to a microorganism that has been altered from its native state and is no longer capable of forming colonies in culture. Inactivated microorganisms may have intact or ruptured cell membranes.

In any of the aspects or embodiments of the present invention whenever mention is made of a particular strain (i.e., with a deposit number), it should be understood that it refers to both the deposited strain and any mutant that can be derived and which maintains the essential characteristics of the starting strain as a plant growth promoter. A “mutant” of any of the strains is also understood as a “variant” of such strain. The skilled in the art will understand that mutants can be obtained routinely, for example by spontaneous mutagenesis or directed mutation, using the strains of the invention as starting material. Methods for obtaining mutants of a specific microbial strain are known in the art. An example can be found in Sambrook, J. and Russell, D. W. “Molecular Cloning: A Laboratory Manual”, Chapter 13, “Mutagenesis”, Cold Spring Harbor, 3rd Ed, 2001.

The term “plant growth promoting agent” as used herein refers to an agent, which can be any of the compositions produced by microorganism cell cultures as defined in this invention and any agricultural composition containing them, that has stimulatory activity on plants in comparison to a negative control or untreated plant, i.e. plants grown under the same conditions but that have not been treated with the compositions of the invention. The expressions “plant growth promoting”, “stimulatory activity on plants” and equivalent expressions as used herein intend to encompass an increase in plant growth and yield in general, as well as an increase and/or improvement in one or more of the following plant features: growth, yield, commercial yield, growth rate, plant growth, plant development, biomass, height, robustness, shoot fresh/dry weight, shoot system fresh/dry weight, root fresh/dry weight, plant fresh/dry weight, leave fresh/dry weight, ear fresh/dry weight, seed fresh/dry weight, aerial part fresh weight /dry weight, shoot number, number of ears, leaves, seeds, flower buds, flower, fruits and/or branches, germination rate, size of leafs, stems, and roots, shoot length, root length, root hair number and length, stalk thickness, carotenoid content, chlorophyll content, flower induction (including reduction in time of floral bud appearance), photosynthesis, crop yield, fruit weight, fruit specific weight, commercial fruit weight, fruit size, fruit ripening, fruit firmness, fruit texture, fruit length, protein content, brix content, pH, emergence rate and resistance to abiotic stress (including heat or cold tolerance, drought tolerance, salt tolerance and others), and the like.

For the purposes of the invention any strain having the capacity of stimulating plant growth (including plant pathogens) may be used for preparing the compositions of the invention.

Non-limiting examples of strains useful in preparing the compositions of this invention are listed in the tables below and are identified by the deposit accession number given by the Colección Española de Cultivos TI PO (CECT), Coli Genetic Stock Center (CGSC), Bacillus Genetic Stock Center (BSGC), German Collection of Microorganisms and Cell Cultures (DSMZ), Microbial Type Culture Collection and Gene Bank (MTCC; India):

| | Source |
|---|---|
| Fungal/yeast species | |
| Alternaria alternata | CECT 2662 |
| Alternaria alternata | CECT 20912 |
| | also deposited as |
| | MTCC5839 |
| Alternaria alternata | CECT 20560 |
| Alternaria alternata | CECT 20923 |
| Alternaria alternata | CECT 20943 |
| Alternaria alternata | DSM-1102 |
| Alternaria alternata | DSM-12633 |
| Alternaria alternata | DSM-62006 |
| Alternaria alternata | DSM-62010 |
| Alternaria alternata | MTCC 1779 |
| Alternaria alternata | MTCC 3793 |
| Alternaria alternata | MTCC 6572 |
| Alternaria alternata | MTCC 7202 |
| Alternaria alternata | MTCC 7959 |
| Alternaria alternata | MTCC 8459 |
| Aspergillus awamori | CECT 2907 |
| Aspergillus brasiliensis | CECT 2091 |
| Beauveria bassiana | CECT 2704 |
| Botrytis aclada | CECT 2851 |
| Colletotrichum gloeosporioides | CECT 20249 |
| Fusarium oxysporum | CECT 20420 |
| Ophiostoma ips | CECT 20676 |
| Paecilomyces clavisporus | CECT 20454 |
| Penicillium charlesii | CECT 20937 |
| Penicillium chrysogenum | CECT 2277 |
| Penicillium digitatum | CECT 20796 |
| Penicillium aurantiogriseum | CECT 20226 |
| Pichia fermentans var. | CECT 10064 |
| Fermentans | |
| Saccharomyces cerevisiae | CECT 13093 |
| NA33 | |
| Trichoderma harzianum | CECT 2413 |
| Verticillium dahliae | CECT 2694 |
| Wickerhamomyces anomalus | CECT 1114 |
| Bacterial species | |
| Bacillus amyloliquefaciens | CECT 493 |
| Bacillus licheniformis | CECT 20 |
| Bacillus pumilus | CECT 29 |
| Bacillus subtilis 168 | BGSCID: 1A1 |
| Burkholderia cepacia | CECT 322 |
| Corynebacterium flavescens | CECT 536 |
| Ensifer fredii | CECT 4369 |
| Escherichia coli | CGSC |
| BW25113 | 7636Yale |
| Pseudomonas fluorescens | CECT 378 |
| Serratia liquefaciens | CECT 483 |
| Serratia odorifera | CECT 867 |
| Stenotrophomonas maltophilia | CECT 7853 |

In addition there are well-known strains of Agrobacterium tumefaciens, Pseudomonas syringae, Salmonella enterica, Bacillus amyloliquefaciens and Bacillus subtilis that are also useful in preparing the compositions of this invention such as Agrobacterium tumefaciens EHA105, Agrobacterium tumefaciens GV2260, Pseudomonas syringae 1448A9, Pseudomonas syringae 49a/90 Pseudomonas syringae PK2, Salmonella enterica LT2, Bacillus amyloliquefaciens IN937a, and Bacillus subtilis GB03.

As mentioned above, a first aspect of the invention relates to a microorganism-free composition obtainable by a method comprising the following steps:

(a) growing a microorganism in an appropriate culture medium; and

(b) removing the microorganism from the culture medium of step a) when the microorganism growth has started the logaritmic growth phase, to obtain the microorganism-free composition,

wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, Penicillium charlesii, Aspergillus awamori, Aspergillus brasiliensis, Colletotrichum gloeosporioides, Ophiostoma ips, Paecilomyces clavisporus, Penicillium digitatum, Pichia fermentans var. fermentans, Saccharomyces cerevisiae, Verticillium dahliae, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Pseudomonas fluorescens, Pseudomonas syringae, Salmonella enterica, Serratia liquefaciens, Serratia odorifera, and Stenotrophomonas maltophilia.

In one embodiment of the invention, optionally in combination with one or more of the embodiments described above or below, the invention relates to a microorganism-free composition, wherein the microorganism is selected from strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Fusarium oxysporum, Wickerhamomyces anomalus, Botrytis aclada, Trichoderma harzianum, Beauveria bassiana, Penicillium charlesii, Aspergillus awamori, Aspergillus brasiliensis, Colletotrichum gloeosporioides, Ophiostoma ips, Paecilomyces clavisporus, Penicillium digitatum, Pichia fermentans var. fermentans, Saccharomyces cerevisiae, Verticillium dahliae, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Pseudomonas fluorescens, Pseudomonas syringae, Salmonella enterica, Serratia liquefaciens, Serratia odorifera, and Stenotrophomonas maltophilia.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, and Penicillium charlesii.

More particularly, the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, strain CECT 20226 of Penicillium aurantiogriseum, strain CGSC 7636 of Escherichia coli BW25113, strain CECT 2704 of Beauveria bassiana, strain CECT 2851 of Botrytis aclada, strain CECT 20420 of Fusarium oxysporum, strain CECT 20937 of Penicillium charlesii, strain CECT 2277 of Penicillium chrysogenum, strain CECT 2413 of Trichoderma harzianum, and strain CECT 1114 of Wickerhamomyces anoml/us.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Fusarium oxysporum, Wickerhamomyces anomalus, Botrytis aclada, Trichoderma harzianum, Beauveria bassiana, and Penicillium charlesii.

In another embodiment of the invention, optionally in combination with one or more of the embodiments described above or below, the invention relates to a microorganism-free composition, wherein the microorganism is selected from the group consisting of: strain

CECT 20912 of Alternaria alternata, strain CECT 20226 of Penicillium aurantiogriseum, strain CECT 2277 of Penicillium chrysogenum and CGSC 7636 of Escherichia coli BW25113.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 20226 of Penicillium aurantiogriseum, strain CECT 2277 of Penicillium chrysogenum, CGSC 7636 of Escherichia coli BW25113, strain CECT 20420 of Fusarium oxysporum, strain CECT 2413 of Trichoderma harzianum, and strain CECT 2851 of Botrytis aclada.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 20226 of Penicillium aurantiogriseum, and CGSC 7636 of Escherichia coli BW25113.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 20226 of Penicillium aurantiogriseum, CGSC 7636 of Escherichia coli BW25113, strain CECT 20420 of Fusarium oxysporum, strain CECT 2413 of Trichoderma harzianum, and strain CECT 2851 of Botrytis aclada.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, strain CECT 20226 of Penicillium aurantiogriseum, Penicillium chrysogenum, Fusarium oxysporum, Wickerhamomyces anomalus, Botrytis aclada, Trichoderma harzianum, Beauveria bassiana, strain CECT 20937 of Penicillium charlesii, Aspergillus awamori, Aspergillus brasiliensis, Colletotrichum gloeosporioides, Ophiostoma ips, Paecilomyces clavisporus, Penicillium digitatum, Pichia fermentans var. fermentans, Verticillium dahliae, strain CECT 493 of Bacillus amyloliquefaciens, Bacillus licheniformis, Bacillus pumilus, Burkholderia cepacia, Corynebacterium flavescens, Ensifer fredii, Pseudomonas fluorescens, Serratia liquefaciens, Serratia odorifera, and Stenotrophomonas maltophilia.

In another embodiment of the invention, optionally in combination with one or more of the embodiments described above or below, the invention relates to a microorganism-free composition, wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, strain CECT 20226 of Penicillium aurantiogriseum, Fusarium oxysporum, Wickerhamomyces anomalus, Botrytis aclada, Trichoderma harzianum, Beauveria bassiana, strain CECT 20937 of Penicillium charlesii, Aspergillus awamori, Aspergillus brasiliensis, Colletotrichum gloeosporioides, Ophiostoma ips, Paecilomyces clavisporus, Penicillium digitatum, Pichia fermentans var. fermentans, Verticillium dahliae, strain CECT 493 of Bacillus amyloliquefaciens, Bacillus licheniformis, Bacillus pumilus, Burkholderia cepacia, Corynebacterium flavescens, Ensifer fredii, Pseudomonas fluorescens, Serratia liquefaciens, Serratia odorifera, and Stenotrophomonas maltophilia.

As mentioned above, the process for obtaining the microorganism-free composition comprises a) growing a microorganism in an appropriate culture medium; and b) removing the microorganism from the culture medium of step a) when the microorganism growth has started the logaritmic growth phase.

In one embodiment of the invention, optionally in combination with one or more of the embodiments described above or below, the microorganism is removed from the culture medium of step a) when the microorganism growth has reached at least a value equal to or higher than 5%, 10%, 20%, 30%, 40%, 50%, 60%, 70%, 80%, 90% of the logaritmic growth phase. More particularly, the microorganism is removed from the culture medium of step a) after the onset of the logaritmic growth phase and before the death phase starts. In an even more particular embodiment, the microorganism is removed from the culture medium of step a) after the onset of the logaritmic growth phase and before the stationary phase starts.

In another also more particular embodiment, the microorganism is removed from the culture medium of step a) after the onset of the stationary phase. Even more particularly, the microorganism is removed from the culture medium of step a) when the microorganism growth has reached at least a value equal to or higher than 5%, 10%, 20%, 30%, 40%, 50%, 60%, 70%, 80%, 90% of the stationary growth phase.

In another embodiment of the invention, optionally in combination with one or more of the embodiments described above or below, step b) is carried out when the colony forming units (CFU) per milliliter is equal or higher than 10³, 10⁴, 10⁵, 10⁶, or 10⁷.

In another embodiment of the invention, optionally in combination with one or more of the embodiments described above or below, in the method for obtaining the microorganism-free composition as defined above, the culture medium of step a) is a medium lacking aminoacids and proteins (for example, a minimal medium).

The term “microorganism culture medium” as used herein refers to a culture medium with components including nutrients, growth factors, minerals, and the like, in which a microorganism is inoculated for its growth.

The term “minimal culture medium” as defined herein refers to a medium that includes only the nutrients that are required by the cells to survive and proliferate in culture, generally without the presence of amino acids. and generally contains inorganic salts as sources of Na, K, Ca, Mg, P, N and S, a carbon source, and water. It may optionally contain one or more additional substances such as vitamins. Non-limiting examples of components of the culture media include CoCl₂.6H₂O; CuSO₄.5H₂O; FeNaEDTA, H₃BO₃; Kl; MnSO₄.H₂O; Na₂MoO₄.2H₂O; ZnSO₄.7H₂O; CaCl₂; KH₂PO₄; KNO₃; MgSO₄; NH₄NO₃; Glycine; myo-Inositol; Nicotinic acid; Pyridoxine HCl; Thiamine HCl; Na₂HPO₄; KH₂PO₄; NaCl NH₄Cl; CaCl₂; MgSO₄.

Non-limiting examples of such minimal media are M9 (95 mM Na₂HPO₄/44 mM KH₂PO₄/17 mM NaCl/37 mM NH₄Cl/0.1 mM CaCl₂/2 mM MgSO₄, 1.5% bacteriological agar), MOPS, Murashige&Skoog (MS), and the like.

The culture medium used in step a) may be liquid or solid. In one embodiment of the invention, optionally in combination with one or more of the embodiments described above or below, the culture medium of step a) is liquid.

In another embodiment of the invention, optionally in combination with one or more of the embodiments described above or below, the appropriate culture medium further comprises an organic compound as carbon source. Non-limiting examples of these compounds include sucrose, glucose, succinate, starch, fructose, maltose, maltotriose, lactose, galactose or xylose.

In another embodiment of the invention, optionally in combination with one or more of the embodiments described above or below, the appropriate culture medium further comprises a compound as nitrogen source. Non-limiting examples of these compounds include NH₄NO₃, NH₄Cl, NaNO₃, KNO₃.

In another embodiment of the invention, optionally in combination with one or more of the embodiments described above or below, the appropriate culture medium is lacking amino acids and/or proteins.

In another embodiment of the invention, optionally in combination with one or more of the embodiments described above or below, the microorganism is grown with no agitation.

In another embodiment of the invention, optionally in combination with one or more of the embodiments described above or below, the microorganism is grown with agitation, in particular from 1 to 300 rpm, more particularly from 1 to 180 rpm, and even more particularly from 1 to 150 rpm.

In another embodiment of the invention, optionally in combination with one or more of the embodiments described above or below, the microorganism is grown at a temperature from 3 to 70° C., more particularly from 15 to 50° C., even more particularly from 20 to 40° C.

The microorganism may be inoculated into the growth culture medium in an aerobic, microaerophilic, or an anaerobic environment.

The microorganisms may be cultivated at small scale (e.g. using flasks or laboratory fermenters) or large-scale (e.g. using industrial fermentators) or fermentation (including but not limited to continuous, batch, fed-batch, or solid state cultures or fermentations) in laboratory or industrial fermenters. Optionally, the culture medium containing the microorganisms may be homogenized or liquified e.g by means of a mixer.

The removal of the microorganisms of the culture medium (step b) to obtain the microorganism free composition may be carried out by any method known to those skilled in the art. Generally, this step may be performed by filtration (e.g. with a filter having an average pore size from 0.5 to 0.1 μm), centrifugation (for example at from 1000 to 6000 rpm), sedimentation (e.g. by gravity), precipitation, flocculation, electro-precipitation or extraction. In one embodiment, step b) is carried out by centrifugation and/or filtration. Depending on the technique used the microorganism-free composition or exudate takes the form of a filtrate, supernatant or extract.

If necessary or desired the process for obtaining the microorganism-free compositions of the invention may include additional steps. For example, after obtaining the microorganism-free composition, it may be freeze-dried, concentrated, ultrafiltrated, granulated, sterilized, clarificated, agglomerated, washed, absorbed, adsorbed, crystallized, precipitated, extracted, dried, distilled, dialized, rectificated,chromatographed, spray dried and depyrogenated, among other possibilities.

In one embodiment of the invention, the invention relates to a microorganism-free composition obtainable by a method comprising the following steps:

(a) growing a microorganism in an appropriate culture medium; and

(b) removing the microorganism from the culture medium of step a) when the microorganism growth has started the logaritmic growth phase, to obtain the microorganism-free composition,

wherein:

the microorganism is selected from the group consisting of: strain CECT 20912 of Alternaria alternata, strain CECT 20226 of Penicillium aurantiogriseum, strain CECT 2277 of Penicillium chrysogenum and CGSC 7636 of Escherichia coli BW25113; the culture medium of step a) is a medium lacking aminoacids and proteins; particularly a liquid medium selected from the group consisting of M9, MOPS, and MS optionally supplemented with vitamins and organic compounds as carbon source;

the microorganism is removed from the culture medium of step a) when the microorganism growth has reached at least a value equal to or higher than 5%, 10%, 20%, 30%, 40%, 50%, 60%, 70%, 80%, 90% of the logaritmic growth phase; and

step b) is performed by centrifugation and/or filtration.

In another embodiment of the invention, the invention relates to a microorganism-free composition obtainable by a method comprising the following steps:

(a) growing a microorganism in an appropriate culture medium; and

(b) removing the microorganism from the culture medium of step a) when the microorganism growth has started the logaritmic growth phase, to obtain the microorganism-free composition,

wherein:

the microorganism is selected from the group consisting of: strain CECT 20912 of Alternaria alternata, strain CECT 20226 of Penicillium aurantiogriseum, strain CECT 2277 of Penicillium chrysogenum, CGSC 7636 of Escherichia coli BW25113, strain CECT 20420 of Fusarium oxysporum, strain CECT 2413 of Trichoderma harzianum, strain CECT 2851 of Botrytis aclada;

the culture medium of step a) is a medium lacking aminoacids and proteins; particularly a liquid medium selected from the group consisting of M9, MOPS, and MS optionally supplemented with vitamins and organic compounds as carbon source;

the microorganism is removed from the culture medium of step a) when the microorganism growth has reached at least a value equal to or higher than 5%, 10%, 20%, 30%, 40%, 50%, 60%, 70%, 80%, 90% of the logaritmic growth phase; and

step b) is performed by centrifugation and/or filtration.

More particularly, in the embodiment above, the microorganism is grown at a temperature from 15 to 50° C., more particularly from 20 to 40° C.

It also forms part of the invention a method for obtaining a microorganism-free composition as defined above which comprises the following steps:

(a) growing a microorganism in an appropriate culture medium; and

(b) removing the microorganism from the microorganism culture medium of step a) when the microorganism growth has started the logaritmic growth phase, to obtain the microorganism-free composition.

The above embodiments mentioned for the microorganism-free composition also apply to the method for its preparation as described above.

Another aspect of the invention relates to a composition comprising an inactivated microorganism obtainable by a method comprising the following steps:

(a) growing a microorganism cell culture in an appropriate medium; and

(b) inactivating the microorganism in the culture medium of step a) when the microorganism growth has started the logaritmic growth phase, to obtain the composition comprising an inactivated microorganism,

wherein the microorganism is selected from the group consisting of Alternaria alternata, Aspergillus awamori, Aspergillus brasiliensis, Beauveria bassiana, Botrytis aclada, Colletotrichum gloeosporioides, Fusarium oxysporum, Ophiostoma ips, Paecilomyces clavisporus, Penicillium charlesii, Penicillium chrysogenum, Penicillium digitatum, Penicillium aurantiogriseum, Pichia fermentans var. fermentans, Saccharomyces cerevisiae, Trichoderma harzianum, Verticillium dahliae, Wickerhamomyces anomalus, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Escherichia coli, Pseudomonas fluorescens, Pseudomonas syringae, Salmonella enterica, Serratia liquefaciens, Serratia odorifera, and Stenotrophomonas maltophilia.

In one embodiment of the invention, optionally in combination with one or more of the embodiments described above or below, the invention relates to a composition comprising an inactivated microorganism, wherein the microorganism is selected from the group consisting of Alternaria alternata, Aspergillus awamori, Aspergillus brasiliensis, Beauveria bassiana, Botrytis aclada, Colletotrichum gloeosporioides, Fusarium oxysporum, Ophiostoma ips, Paecilomyces c/avisporus, Penicillium char/esii, Penicillium digitatum, Penicillium aurantiogriseum, Pichia fermentans var. fermentans, Saccharomyces cerevisiae, Trichoderma harzianum, Verticillium dahliae, Wickerhamomyces anomalus, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Escherichia coli, Pseudomonas fluorescens, Pseudomonas syringae, Salmonella enterica, Serratia liquefaciens, Serratia odorifera, and Stenotrophomonas maltophilia.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, and Penicillium charlesii.

More particularly, the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, strain CECT 20226 of Penicillium aurantiogriseum, strain CGSC 7636 of Escherichia coli BW25113, strain CECT 2704 of Beauveria bassiana, strain CECT 2851 of Botrytis aclada, strain CECT 20420 of Fusarium oxysporum, strain CECT 20937 of Penicillium charlesii, strain CECT 2277 of Penicillium chrysogenum, strain CECT 2413 of Trichoderma harzianum, and strain CECT 1114 of Wickerhamomyces anomalus.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Fusarium oxysporum, Wickerhamomyces anomalus, Botrytis aclada, Trichoderma harzianum, Beauveria bassiana, and Penicillium charlesii.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, strain CECT 20226 of Penicillium aurantiogriseum, strain CECT 2277 of Penicillium chrysogenum and CGSC 7636 of Escherichia coli BW25113.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, strain CECT 20226 of Penicillium aurantiogriseum, strain CECT 2277 of Penicillium chrysogenum, CGSC 7636 of Escherichia coli BW25113, strain CECT 20420 of Fusarium oxysporum, strain CECT 2413 of Trichoderma harzianum, strain CECT 2851 of Botrytis aclada.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, strain CECT 20226 of Penicillium aurantiogriseum, and CGSC 7636 of Escherichia coli BW25113.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, strain CECT 20226 of Penicillium aurantiogriseum, CGSC 7636 of Escherichia coli BW25113, strain CECT 20420 of Fusarium oxysporum, strain CECT 2413 of Trichoderma harzianum, strain CECT 2851 of Botrytis aclada.

In another embodiment of the invention, optionally in combination with one or more of the embodiments described above or below, the invention relates to a composition comprising an inactivated microorganism, wherein the microorganism is selected from the group consisting of: strain CECT 20912 of Alternaria alternata, and strain CECT 20226 of Penicillium aurantiogriseum.

The step a) of growing the microorganism in an appropriate culture in the method for obtaining a composition comprising an inactivated microorganism as defined above may be carried out in the conditions previously indicated for step a) in the method for obtaining a microorganism-free composition.

The microorganisms may be inactivated by any method known to those skilled in the art, for example by cell lysis. In this case the obtained composition is a lysate. Other suitable methods for inactivating the microorganism include heat shock (e.g. in an autoclave), radiation, osmotic shock, addition of antimicrobial agents, and the like.

As used herein, a “lysate” refers to the composition obtained after the destruction or dissolution of biological cells via cell lysis which results in the release of the intracellular biological constituents contained in the cells of the microorganism. Cell lysis may be accomplished via various techniques, such as an osmotic shock, a thermic shock, via ultrasonication, or alternatively under a mechanical stress of centrifugation type.

If necessary or desired, the process for obtaining the compositions of the invention comprising inactivated microorganisms may include additional steps. For example, after obtaining the compositions of the invention comprising inactivated microorganisms, it may be freeze-dried, concentrated, ultrafiltrated, granulated, sterilized, clarificated, agglomerated, washed, absorbed, adsorbed, crystallized, precipitated, extracted, dried, distilled, dialized, rectificated,chromatographed, fractionated, spray dried and depyrogenated, among other possibilities.

In one embodiment of the invention, the invention relates to a composition comprising an inactivated microorganism obtainable by a method comprising the following steps:

(a) growing a microorganism cell culture in an appropriate medium and

(b) inactivating the microorganism in the culture medium of step a) when the microorganism growth has started the logaritmic growth phase, to obtain the composition comprising an inactivated microorganism,

wherein:

the microorganism is selected from the group consisting of: strain CECT 20912 of Alternaria alternata, strain CECT 20226 of Penicillium aurantiogriseum, strain CECT 2277 of Penicillium chrysogenum, CGSC 7636 of Escherichia coli BW25113, strain CECT 20420 of Fusarium oxysporum, strain CECT 2413 of Trichoderma harzianum, strain CECT 2851 of Botrytis aclada; more particularly the microorganism is strain CECT 20912 of Alternaria alternata or strain CECT 20226 of Penicillium aurantiogriseum;

the culture medium of step a) is a medium lacking aminoacids and proteins; particularly a liquid medium selected from the group consisting of M9, MOPS, and MS optionally supplemented with vitamins and organic compounds as carbon source;

the microorganism is removed from the culture medium of step a) when the microorganism growth has reached at least a value equal to or higher than 5%, 10%, 20%, 30%, 40%, 50%, 60%, 70%, 80%, 90% of the logaritmic growth phase; and

step b) is performed by heat shock.

More particularly, in the embodiment above, the microorganism is grown at a temperature from 15 to 50° C., more particularly from 20 to 40° C.

It also forms part of the invention a method for obtaining a composition comprising an inactivated microorganism as defined above which comprises the following steps:

(a) growing a microorganism cell culture in an appropriate medium and

(b) inactivating the microorganism in the culture medium of step a) when the microorganism growth has started the logaritmic growth phase, to obtain the composition comprising an inactivated microorganism.

The above embodiments mentioned for the composition comprising an inactivated microorganism also apply to the method for its preparation as described above.

Alternatively to the compositions and methods described above, the inventors have found that when plants are cultured in a closed atmosphere in the presence of certain microorganism cultures emitting VOCs, also an effect in plant growth is achieved even when no physical contact between the plant and the microorganism exists. In this embodiment, the microorganism is cultured in a site different from the plant culture site but preferably close enough to the plant so that the VOCs emitted by the microorganism may contact the plant and exert their effect thereon. Since the microorganism and the plant do not enter into contact when using this method, also pathogen microorganisms can be used for generating VOCs.

Thus, the present invention also relates to a method for increasing the growth of a plant comprising administering to the plant in the presence of a VOCs-producing microorganism culture, without there being any contact between the plant and the microorganism, or in the presence of volatiles emitted by the microorganism, wherein the microorganism is selected from

the group consisting of strain CECT 20912 of Alternaria alternata, CECT 2662 of Alternaria alternata, strain CECT 20937 of Penicillium charlesii, strain CECT 20226 of Penicillium aurantiogriseum, and strain CECT 493 of Bacillus amyloliquefaciens, or alternatively, the microorganism is selected from the group consisting of Aspergillus awamori, Aspergillus brasiliensis, Beauveria bassiana, Botrytis aclada, Colletotrichum gloeosporioides, Fusarium oxysporum, Ophiostoma ips, Paecilomyces clavisporus, Penicillium chrysogenum, Penicillium digitatum, Pichia fermentans var. fermentans, Trichoderma harzianum, Verticillium dahliae, Wickerhamomyces anomalus, Bacillus licheniformis, Bacillus pumilus, Burkholderia cepacia, Corynebacterium flavescens, Ensifer fredii, Pseudomonas fluorescens, Serratia liquefaciens, Serratia odorifera, and Stenotrophomonas maltophilia. In one embodiment of this aspect, the method is performed in a greenhouse.

More particularly in the above aspect, the microorganism of the VOCs-producing microorganism culture is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of Alternaria alternata strain DSM-62010 of Alternaria alternata, strain MTCC 1779 of Alternaria alternata strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, and Penicillium charlesii.

Even more particularly, the microorganism of the VOCs-producing microorganism culture is selected from the group consisting of: strain CECT 20912 of Alternaria alternata, strain CECT 2662 of Alternaria alternata, strain CECT 20560 of Alternaria alternata, strain CECT 20923 of Alternaria alternata, strain CECT 20943 of Alternaria alternata, strain DSM-1102 of Alternaria alternata, strain DSM-12633 of Alternaria alternata, strain DSM-62006 of

Alternaria alternata, strain DSM-62010 of Alternaria alternata, strain MTCC 1779 of Alternaria alternata, strain MTCC 3793 of Alternaria alternata, strain MTCC 6572 of Alternaria alternata, strain MTCC 7202 of Alternaria alternata, strain MTCC 7959 of Alternaria alternata, strain MTCC 8459 of Alternaria alternata, strain CECT 20226 of Penicillium aurantiogriseum, strain CGSC 7636 of Escherichia coli BW25113, strain CECT 2704 of Beauveria bassiana, strain CECT 2851 of Botrytis aclada, strain CECT 20420 of Fusarium oxysporum, strain CECT 20937 of Penicillium charlesii, strain CECT 2277 of Penicillium chrysogenum, strain CECT 2413 of Trichoderma harzianum, and strain CECT 1114 of Wickerhamomyces anomalus.

In an even more particular embodiment of the invention, optionally in combination with one or more of the embodiments described above or below, the microorganism of the VOCs-producing microorganism culture is selected from the group consisting of strain CECT 20912 of Alternaria alternata, strain CECT 20226 of Penicillium aurantiogriseum, strain CECT 2277 of Penicillium chrysogenum and CGSC 7636 of Escherichia coli BW25113.

In another more particular embodiment of the invention, optionally in combination with one or more of the embodiments described above or below, the microorganism of the VOCs-producing microorganism culture is selected from the group consisting of: strain CECT 20912 of Alternaria alternata, strain CECT 20226 of Penicillium aurantiogriseum, strain CECT 2277 of Penicillium chrysogenum, CGSC 7636 of Escherichia coli BW25113, strain CECT 20420 of Fusarium oxysporum, strain CECT 2413 of Trichoderma harzianum, and strain CECT 2851 of Botrytis aclada.

The compositions of the invention produced by microorganism cell cultures including the microorganism-free compositions and the compositions comprising inactivated microorganisms as defined above may be applied directly on the plant. i.e., without the addition of any further components, or may be formulated into agricultural compositions. When the compositions of the invention produced by microorganism cell cultures are directly applied they may be diluted before its application. For example, dilutions 1:2, 1:4, and 1:8 in water may be used.

The skilled in the art will know how to adjust the most appropriate concentration or dose of the compositions of the invention depending on the type of the plant, the part to be treated and/or the desired effect.

The agricultural composition of the invention comprises an effective amount of the compositions of the invention produced by microorganism cell cultures as defined above together with one or more agriculturally acceptable carriers.

The term “effective amount” as used herein refers to the amount of the compositions produced by microorganism cell cultures as defined above, which after its application is sufficient to provide a beneficial effect on the plant, i.e, to enhance or increase or improve one or more of the following plant features: growth, yield, commercial yield, growth rate, plant growth, plant development, biomass, height, robustness, shoot fresh/dry weight, shoot system fresh/dry weight, root fresh/dry weight, plant fresh/dry weight, leave fresh/dry weight, ear fresh/dry weight, seed fresh/dry weight, aerial part fresh weight /dry weight, shoot number, number of ears, leaves, seeds, flower buds, flower, fruits and/or branches, germination rate, size of leafs, stems, and roots, shoot length, root length, root hair number and length, stalk thickness, carotenoid content, chlorophyll content, flower induction (including reduction in time of floral bud appearance), photosynthesis, crop yield, fruit weight, fruit specific weight, commercial fruit weight, fruit size, fruit ripening, fruit firmness, fruit texture, fruit length, protein content, Brix content, pH, emergence rate and resistance to abiotic stress (including heat or cold tolerance, drought tolerance, salt tolerance and others), and the like.

The term “agriculturally acceptable carrier” as used herein refers to a material which can be used to improve the delivery, storage, application of the compositions produced by microorganism cell cultures to a plant or a part of the plant such as for example a seed, a leaf or a root, without having an adverse effect on the soil or the like. The agriculturally acceptable carrier must be compatible with the compositions produced by microorganism cell cultures in the sense that it does not impair the effectiveness of these compositions and which by itself has no significant detrimental effect on the soil, equipment, desirable plants, or the agronomic environment. Examples of agriculturally acceptable carrier include, without limitation, adjuvants, diluents, surfactants, conditioning agents, antifreezes, antifoaming agents, thickeners, wetting agents, spreading agents, dispersing agents, emulsifying agents, antimicrobial agents and the like.

The agricultural compositions may be in the form of particulate solids, solutions, dispersions, suspensions or emulsions.

In another embodiment of the invention, optionally in combination with one or more of the embodiments described above or below, the invention relates to an agricultural composition further comprising one or more additives selected from the group consisting of herbicides, pesticides, fungicides and fertilizers.

The compositions of the invention including the compositions produced by microorganism cell cultures as well as the agricultural compositions containing them can be used as plant growth promoting agents. Thus, it also forms part of the invention a method for promoting stimulatory activity on a plant comprising administering to the plant with an effective amount of a composition as defined above. In this method the plant is physically contacted with the treating composition.

In one embodiment of the method, optionally in combination with one or more of the embodiments described above or below, promoting stimulatory activity on a plant comprises an increase or improvement in one or more of the plant features selected from the group consisting of growth, yield, commercial yield, growth rate, plant growth, plant development, biomass, height, robustness, shoot fresh/dry weight, shoot system fresh/dry weight, root fresh/dry weight, plant fresh/dry weight, leave fresh/dry weight, ear fresh/dry weight, seed fresh/dry weight, aerial part fresh weight/dry weight, shoot number, number of ears, leaves, seeds, flower buds, flower, fruits and/or branches, germination rate, size of leafs, stems, and roots, shoot length, root length, root hair number and length, stalk thickness, carotenoid content, chlorophyll content, flower induction (including reduction in time of floral bud appearance), photosynthesis, crop yield, fruit weight, fruit specific weight, commercial fruit weight, fruit size, fruit ripening, fruit firmness, fruit texture, fruit length, protein content, Brix content, pH, emergence rate and resistance to abiotic stress (including heat or cold tolerance, drought tolerance, salt tolerance and others), and the like. More particularly, the enhancement or increase in one or more of the plant features defined above is relative to a control plant that has not received the treatment with the compositions of the invention.

More particularly, promoting stimulatory activity on a plant comprises an increase in one or more of the plant features selected from the group consisting of yield, commercial yield, plant growth, plant development, shoot number, leaves fresh weight, shoot length, root length, shoot fresh/dry weight, shoot system fresh/dry weight, root fresh/dry weight, aerial part fresh/dry weight, ear fresh/dry weight, seed fresh/dry weight, root fresh/dry weight, number of ears, chlorophyll and protein content, emergence rate and resistance to abiotic stress.

In another embodiment of the method invention, optionally in combination with one or more of the embodiments described above or below, the plant is an angiosperm or a gimnosperm, monocotyledon or dicotyledon. Non-limiting examples of plants include a potato plant, a maize plant, a pepper plant, a tobacco plant, an Arabidopsis thaliana plant, a cucumber plant, a tomato plant, a cabbage plant, a wheat plant, a barley plant, a soybean plant, a corn plant, a cotton plant, a rice plant, a rape plant, an oilseed rape plant, a sunflower plant, an alfalfa plant, a sugarcane plant, a grass plant, a blackberry plant, a blueberry plant, a strawberry plant, a raspberry plant, a carrot plant, a cauliflower plant, a coffee plant, a melon plant, an eggplant, a lettuce plant, an onion plant, a pea plant, a spinach plant, a watermelon plant, a mint plant, a broccoli plant, a shallot plant, a Brussels sprout plant, a kohlrabi plant, a currant plant, an artichoke plant, an endive plant, a leek plant, a cassava plant, a turnip plant, a radish plant, a yam plant, a sweet potato plant, a bean plant, a pumpkin plant, a garlic plant, a rye plant, a millet plant, a sorghum plant, a rapeseed plant, an arrowroot plant, a clover plant, a squash plant, a banana tree, a pomelo tree, a mango tree, a papaya tree, a pineapple tree, an apple tree, a peach tree, a pear tree, a cherry tree, a plum tree, an avocado tree, an orange tree, a lemon tree, a tangerine tree, an almond tree, a walnut tree, a pistachio tree, a peanut tree, a hazelnut tree, a chestnut tree, a macadamia tree, a cashew tree, a coconut tree, a palm tree, a Eucalyptus tree, an oak tree, an elm tree, a maple tree, a beech tree, a poplar tree, an ash tree, a pecan tree, a birch tree, a fir tree, a juniper tree, a yew tree, a cedar tree, a cypress tree, a redwood tree and the like.

In a particular embodiment of the method invention, optionally in combination with one or more of the embodiments described above or below, the plant is selected from the group consisting of an Arabidopsis plant, a cereal plant such as a corn plant, a wheat plant or a maize plant, a soybean plant, a rapeseed plant, a cotton plant, a sunflower plant, an alfalfa plant, a sugar cane plant, a sorghum plant, a tomato plant, a pepper plant, a potato plant, a grass plant, and a rice plant.

In one embodiment of the method, optionally in combination with one or more of the embodiments described above or below, the plant is cultured in vitro or in soil.

The compositions of the invention may be applied to any part of the plant, including any “above-ground” part or shoot system, or any “below-ground” part of the plant or root system. The “above-ground” part or shoot system encompasses those parts of the plant present above the soil or the medium in which the plant is growing. Non-limiting examples of above-ground parts of the plant include leaves, flowers, seeds, fruits, buds, stems, branches, an inflorescence, or a seed-bearing structure of the plant. The “below-ground” part or root system encompasses those parts present below the soil or the medium in which the plant is growing. Non-limiting examples of below-ground parts of the plant include roots, root hairs, tubers and rhizomes.

In one embodiment of the method, optionally in combination with one or more of the embodiments described above or below, the compositions of the invention are applied to an above-ground part of the plant.

In another embodiment of the method, optionally in combination with one or more of the embodiments described above or below, the compositions of the invention are applied to a below-ground part of the plant. Generally, the compositions can be applied to the plant continuously or at one or more specific development stages depending on the desired effect to be achieved. For example the compositions can be applied at any stage of growth such as to a germination, seedling, growth, reproductive, or seed stage, at pre-flowering stage, onset of flowering, or onset of ripening. Alternatively, they may be applied in one or more stages of growth of the plant. The skilled in the art will know the most appropriate administration pattern to be used at a determined plant growth stage and the most appropriate part of the plant to apply the compositions of the invention depending on the desired effect.

Examples of application of the compositions of the invention including the compositions produced by microorganism cultures and the agricultural compositions containing them include, without limitation, irrigation, fumigation, soil or root application or injection, trunk or branch injection, or in a spray applied to leaves, stems, buds, inflorescences, flowers, seeds or fruit. These compositions may also be applied in a greenhouse.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim, and shall not be construed as limiting the scope of the claim. Furthermore, the present invention covers all possible combinations of particular and preferred embodiments described herein.

### EXAMPLES

### Example 1. Effects of Microorganism-Free Compositions and Compositions Containing Inactivated Microorganisms Produced by Microorganism Cell Cultures in Plants

Microbial Cultures and Growth Conditions

The microorganisms and culturing conditions used in this study were the following:

Fungi: strain CECT 20912 of Alternaria alternata, strain CECT 20226 of Penicillium aurantiogriseum, strain CECT 2277 of Penicillium chrysogenum, strain CECT 20420 of Fusarium oxysporum, strain CECT 2413 of Trichoderma harzianum, strain CECT 2851 of B. aclada.

Culture medium: Liquid MS supplemented with vitamins and sucrose. (pH of the medium before autoclaved was 5.8).

Method 1: A 1000 mL flask with 600 mL liquid MS medium was inoculated with a 4 mL concentrated mycelial sample and allowed to grow at 28° C. for seven days with shaking at 130 rpm. This “seed material” was then inoculated into 5 L fermenter, and incubated for an additional 3 days with maximum aeration (1 vvm) (vvm=gas volume flow per unit of liquid volume per minute (volume per volume per minute). At the end of the fermentation, the culture broth containing the microorganism was centrifuged at 4000 rpm for 30 min for separating the microbial cells. The supernatant was then filtrated through a 0.2 μm filter apparatus to create the final undiluted sterile composition.

Variations of method 1 were also performed, wherein the microorganism growth was carried out with more steps of incubation of the seed material and/or wherein the shaking was carried out at 150 rpm and/or wherein at the end of the fermentation the culture broth was filtered through an absorbent cotton gauze instead of being centrifuged. The growth temperature for P. aurantiogriseum, Fusarium oxysporum, and B. aclada was of 24° C.

Method 2: Same as Method 1 but with the following specific parameters:
500 mL flask with 300 mL liquid MS media+2 mL concentrated mycelial sample for inoculation as seed material into 3 L fermenter.

Method 3: Same as method 1 but with the following specific parameters:
250 mL flask with 100 mL liquid MS media+1 mL concentrated mycelial sample for inoculation as seed material into 3 L flask with 1 L MS (150 rpm).

Method 4: Same as Method 1 but with the following specific parameters:
An inoculum of 160 mL was prepared in a 500 mL Erlenmeyer flask containing 298 mL of MS+2 mL concentrated mycelial sample
With the above inoculum of 300 mL+2700mL MS medium, a fermentation of 3 L was prepared in a 5 L fermenter.
With the above inoculum 3 L+25 L MS medium, 28 L fermentation was prepared in a 40 L fermenter.

Method 5: Same as Method 1 but with the following specific parameters:
An inoculum of 160 ml was prepared in a 500 mL Erlenmeyer flask containing 298 mL of MS+2 mL concentrated mycelial sample (duplicate).
With the above inoculum of 160 ml+1440 mL MS medium, a fermentation of 1.6 L was prepared in a 2 L fermenter (duplicate).
With the above inoculum 14.4 L+1.6 L MS medium, 16 L fermentation was prepared in a 20 L fermenter, (duplicate).With the above fermentation (32 L of inoculum)+128 L MS medium, 160 L fermentation was prepared in a 200 L fermenter.

Method 6: Similar to Method 1 but including a liquification step with a domestic mixer instead of centrifugation step.

Method 7: Similar to Method 1 but including a autoclaving step (121° C., 20 min) instead of the 0.2 μm filtration.

Method 8: Distillation method

Distillation was performed using a ROTARY VACUUM EVAPORATOR (STUART RE 300), water bath (STUART RE 3000B) and vacuum pump (ILMVAC, ref: LVS 105 T-10 ef) under the following conditions: Water bath temperature: 60° C., initial vacuum pressure: 200 mbar. The process was stopped when half of the initial volume was distilled. The rest of the volume was called “the concentrate”.

Method 9: A 1000 mL flask with 300 mL liquid MS medium supplemented with 90 mM sucrose was inoculated with a 2 mL concentrated mycelial sample and allowed to grow at 28° C. with shaking at 180 rpm for a week. This “seed material” was then inoculated in a 2000 mL flask with 1000 mL liquid MS medium, supplemented with 90 mM sucrose incubated at 28° C. for 3 days. After that, the culture medium was filtered through miracloth. Part of the filtrate was then filtered through a 0.2 μm filter apparatus to create the final undiluted filtered composition. Part of the miracloth-filtered medium was distilled using a R3000 (BUCHI) rotavapor at 50° C. to create the final undiluted distilled composition.

Greenhouse: Plants were irrigated with the compositions diluted in water (1:3) for 6 weeks, once a week, with increasing volumes (5, 10, 20, 40, 60 and 80 mL per pot).

Field: 2 applications: 1 and 2 months after sowing. Each time, 2 L of selected treatment (1× solution) was applied (4 L in total; 417 L/ha).

Method 10: Similar to Method 1 but the following media instead of MS medium was used: Potato Dextrose Agar (PDA): Diced potatoes 300 g, Dextrose (Glucose) 20 g, Distilled water 1 L.

Bacteria: Escherichia coli BW25113 CGSC 7636.Yale

Culture medium: M9.

Method 11: 11 mL of LB liquid medium was added to each two 50 mL centrifuge sterile tubes. 250 μL of inoculum from a stock of E. coli was added to each tube, which were incubated at 37° C., 150 rpm, for 6 hours. After this time, two 250 mL flasks with 95 mL of M9 were inoculated with 5 mL of the LB-grown E. coli inoculum per tube, and incubated at 37° C., 150 rpm, for 18 hours aprox. After that two 2 L conical flasks with 900 mL of M9 each were inoculated with 80 mL each of the M9-grown E. coli, incubated at 37° C., 150 rpm, one flask for 24 hours and the other for 48 h. Finished fermentation times, the culture medium was filtered and packaged in sterile bottles.

Variations of method 11 were also performed, wherein the microorganism growth was carried out for 3.5 hours in the first step and 21 hours in the second step.

Plant Cultures and Growth Conditions

The plants used in these experiments were cultured and grown under the following conditions:

| | Temperature | | Light | Time |
|---|---|---|---|---|
| Phase | (° C.) | Humidity % | (%) | (min) |
| 0 | 25 | 50 | 100 | 1 |
| 1 | 25 | 50 | 100 | 840 |
| 2 | 23 | 60 | 40 | 60 |
| 3 | 20 | 80 | 10 | 60 |
| 4 | 20 | 80 | 0 | 360 |
| 5 | 20 | 80 | 10 | 60 |
| 6 | 23 | 60 | 40 | 60 |

Plant growth conditions in the automatized platform:
Corn seeds were sown in pots with soil, (one seed per pot) with 80% water content (normal conditions) or 25% polyethylenglycol (drought conditions) for 8 days (22° C./20° C. in 16/8 h light/dark cycle, photon irradiance of 120 μmol photons of PAR m-2 s-1, relative humidity of 60%). Every 2 hours, the system (PlantScreen™ system (Photon Systems Instruments, Brno, Czech Republic)) took photographs of the pots, and image processing software detected and identified the first green pixels of a seedling newly emerged above the soil. Emergence rate and total number of emerged seedlings were provided by in-house software (implemented in MatLab R2015) departing from the fraction of emerged seedlings found as a function of time.

### Example 1.1 Effects of a Microorganism-Free Composition Produced by a Penicillium Aurantiogriseum Cell Culture in Arabidopsis Thaliana

Sterilized Arabidopsis thaliana WT-Col-0 seeds were sown in plates with MS agar and vitamins and stored at 4° C. for 3 days in darkness before being, transferred to a growth chamber, for one week. After that, the plants were transplanted to small pots with soil and maintained for two weeks in the same growing conditions. Application of the composition:

165 μL of filtered culture medium produced by Penicillium aurantiogriseum (obtained as described above in method 3) and 495 μL H₂O were applied to each plant, directly to the soil near to roots. The composition was applied once, at the beginning of the light phase (phase 5). For biomass determinations, all the leaves except the cotyledons were harvested one week after application of the composition. An increase of 9.8% in rossete leaves fresh weight (FVV) of the plants treated with the microorganism-free composition produced by a Penicillium aurantiogriseum cell culture was observed in comparison to control untreated plants.

### Example 1.2 Effects of a Microorganism-Free Composition Produced by a Penicillium Aurantiogriseum Cell Culture in Tomato Seeds

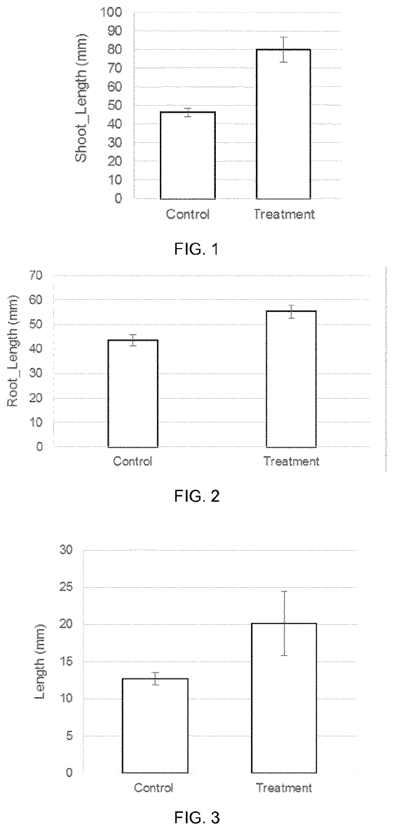

Sterilized tomato seeds were sown in 12-well, flat bottom cell culture plates filled with 6 mL of sterile wet perlite +400 μL H₂O aprox. in each well. The filtered culture medium produced by Penicillium aurantiogriseum (obtained as described above in method 3) was applied at a dose of 26.6 μL on the seed. The plates were stored at 24° C. for 7 days in darkness and then for 7 days in a growth chamber with the photoperiod described above. Germination rate was assessed. Material was then harvested and shoot and root biomass and length, were measured. The increase in shoot length of the plants treated with the microorganism-free composition produced by a Penicillium aurantiogriseum cell culture compared to control untreated plants is shown in FIG. 1.

### Example 1.3 Effects of a Microorganism-Free Composition Produced by a Penicillium Aurantioqriseum Cell Culture in Corn Seeds

Sterilized corn seeds were sown in 6-well, flat bottom cell culture plates filled with 12 mL of sterile wet perlite 12 mL/well +800 μL H₂O aprox. in each well. The filtered culture medium produced by Penicillium aurantiogriseum (obtained as described above in method 3) was applied at a dose of 53.2 μL on the seed. The plates were stored at 24° C. for 3 days in darkness and then for 7 days in a growth chamber with the photoperiod described above. Germination rate was assessed. Material was then harvested and shoot and root biomass and length, were measured. 12% increase in the germination rate on the fourth day of the trial was observed. An increase of 83.7% in aerial part fresh weight (FVV) and of 63.8% in aerial part dry weight (DVV) of the plants treated with the microorganism-free composition produced by a Penicillium aurantiogriseum cell culture was observed in comparison to control untreated plants.

### Example 1.4 Effects of a Microorganism-Free Composition Produced by a Penicillium Chrysogenum Cell Culture in Arabidopsis Thaliana

Sterilized Arabidopsis thaliana WT-Col-0 seeds were sown in plates with MS agar and vitamins and stored at 4° C. for 3 days in darkness before being, transferred to a growth chamber, for one week. After that, the plants were transplanted to small pots with soil and maintained for two weeks in the same growing conditions. Application of the composition: 165 μL of filtered culture medium produced by Penicillium chrysogenum (obtained as described above in method 3) and 495 μL H₂O were applied to each plant, directly to the soil near to roots. The composition was applicated once, at the beginning of the light phase at the adequate rate. For biomass determinations, all the leaves except the cotyledons were harvested one week after application of products.

### Example 1.5 Effects of a Microorganism-Free Composition Produced by a Penicillium Chrysogenum Culture in Corn Seeds

Sterilized corn seeds were sown in 6-well, flat bottom cell culture plates filled with 12 mL of wet perlite 12 mL/well +800 μL H₂O aprox. in each well. The filtered culture medium produced by Penicillium chrysogenum (obtained as described above in method 3) was applied at a dose of 53.2 μL on the seed . The plates were stored at 24° C. for 3 days in darkness and then for 7 days in a growth chamber with the photoperiod described above. Germination rate was assessed. Material was then harvested and shoot and root biomass and length, were measured.

### Example 1.6 Effects of a Microorganism-Free Composition Produced by a Escherichia Coli Cell Culture in Tomato Seeds

Sterilized tomato seeds were sown in 12-well, flat bottom cell culture plates filled with MS solid medium and the filtered culture medium produced by Escherichia coli (obtained as described above) was applied on the seed, at a dose of 26.6 μL. The plates were stored at 24° C. for 7 days in darkness and then for 7 days in a growth chamber with the photoperiod described above. Germination rate was assessed. Material was then harvested and shoot and root biomass and length, were measured. The increase in root length of the plants treated with the microorganism-free composition produced by a Escherichia coli cell culture compared to control untreated plants is shown in FIG. 2.

### Example 1.7 Effects of a Microorganism-Free Composition Produced by a Alternaria Alternata Cell Culture in Wheat Seeds

Sterilized wheat seeds were sown in 12-well, flat bottom cell culture plates filled with perlite 6 mL of sterile wet perlite +400 μL H₂O aprox in each well, and the filtered culture medium produced by Alternaria alternata (obtained as described above in method 1) was applied on the seed, at a dose of 26.6 μL. The plates were incubated in the growth chamber for 17 days. Germination rate was assessed. Material was then harvested and shoot and root biomass and length, were measured. An increase of 16.3% in root fresh weight (FVV) and of 15.2% in root dry weight (DVV) of the treated plants was observed in comparison to control untreated plants.

### Example 1.8 Effects of a Microorganism-Free Composition Produced by a Alternaria Alternata Cell Culture in Tomato Seeds

Sterilized tomato seeds were sown in 12-well, flat bottom cell culture plates filled with aprox 6 mL of sterile wet perlite +400 μL H₂O aprox in each well or 6 mL of wet soil substrate and the filtered culture medium produced by Alternaria Alternata (obtained as described above in method 1) was applied on the seed, at a dose of 26.6 μL. The plates were stored at 24° C. for 7 days in darkness and then for 7 days in a growth chamber with the photoperiod described above. Germination rate was assessed. Material was then harvested and shoot and root biomass and length, were measured. An increase of 10.7% in shoot length and of 23.1% in root length of the treated tomato plants was observed in comparison to control untreated plants. The increase in root length of the treated tomato plants in soil substrate compared to control untreated plants is shown in FIG. 3.

### Example 1.9 Effects of a Microorganism-Free Composition Produced by a Alternaria alternata Cell Culture in Tomato Plants (Field Trial)

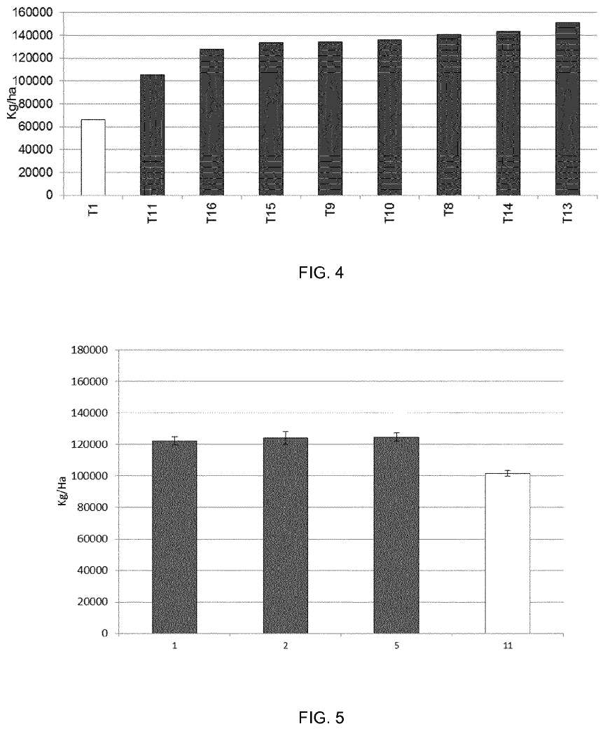

2 dilutions (1:2 and 1:4) in water of filtered culture medium produced by Alternaria alternata (obtained as described above in method 2) were applied in the form of flood irrigation during pre-flowering, onset of flowering, and continuous (irrigation) to 270 tomato plants cultivated in open field from June to October. Distance between plants was 90 cm between lines and 30 cm between plants in each line in a total area of 100 m². Typical phytosanitary and fertilization treatments (50 UF/ha, two times) were applied both to control plants and to plants treated with the filtered culture medium. After harvest, more than 20% increase in total yield depending on the dose and treatment and more than 50% increase in mature fruit yield were observed. The higher yields were obtained when the application was done prior or on the onset of the flowering. Fruit size increased and no negative effects observed in fruit firmness or brix content were observed. The increase in the net yield (acceptable raw material) of the treated tomato plants compared to control untreated plants is shown in FIG. 4. The different applied treatments were carried out as follows:

| Control | | | | T1 |
|---|---|---|---|---|
| | Treatment | Dil ½ | Continuous application | T8 |
| | | | Pre-flowering | T9 |
| | | | Onset of flowering | T10 |
| | | | Onset of ripening | T11 |
| | | Dil ¼ | Continuous application | T13 |
| | | | Pre-flowering | T14 |
| | | | Onset of flowering | T15 |
| | | | Onset of ripening | T16 |

### Example 1.10 Effects of a Microorganism-Free Composition Produced by Alternaria AlternataCell Culture in Tomato Plants (Field Trial)

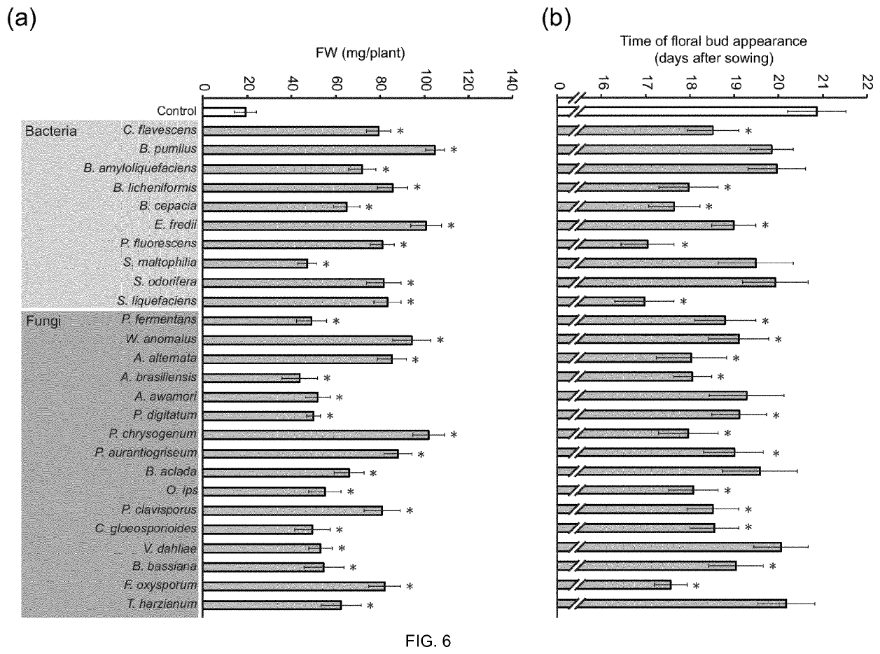

1:4 dilutions of filtered culture medium produced by Alternaria alternata (obtained as described above) produced either in flask (method 3) or in fermenter of a volume of 40 L (method 4) and with sucrose concentrations of 15 g/L or 30 gl/L was applied in the form of drip irrigation twice during the growing cycle to a total number of 150 tomato plants cultivated in open field from May to September. Typical phytosanitary and fertilization treatments were applied both to control plants and to plants treated with the filtered culture medium. An increase in gross production (total number of fruits harvested), net production (ripe fruits), in the percentage of ripe fruits and in the average net yield (acceptable raw material) compared to control plants were observed both in treatments where Alternaria alternata was grown in flask or fermentor. Additional data showed that the amount of overripe fruits is smaller in all treatments (and mainly due to small green fruits and not to rotten fruits) than in control. Furthermore, no relevant variations in pH and ° Brix value were observed, though small increment in fruit firmness is observed in some of the applied treatments. The increase in the net yield (acceptable raw material) of the treated tomato plants compared to control untreated plants is shown in FIG. 5, where the different treatments were carried out as follows:

| | |
|---|---|
| Number | TREATMENTS |

| | | |
|---|---|---|
| 1 | Flask | 15 g/L |
| 2 | Flask | 30 g/L |
| 5 | Fermentor vessel 40 L | 30 g/L |
| 11 | Control | Water |

### Example 1.11 Effects of a Microorganism-Free Composition Produced by a Alternaria Alternata Cell Culture in Rice Plants (Field Trial)

1:4 dilutions in water of the filtered culture medium produced by produced by Alternaria Alternata (obtained as described above in method 5) were spray applied (700 L/ha) by a single application in two rice varieties. Application to variety 1 (Puntal) was made before flowering and to variety 2 (Hispamar) during flowering. The trial had a total rice cultivation area of 90 m² in the open field. The results showed an increase in total production (kg/ha) and an increase in the % of whole grain (2%). Changes in starch content by FW units were not observed. For variety 1 (Puntal) an increase of more than 100 kg/ha was achieved in the treated rice plants compared to control untreated plants, and for variety 2 the increase was of more than 240 Kg/ha.

### Example 1.12 Effects of a Microorganism-Free Composition Produced by a Alternaria Alternata Cell Culture in Corn Plants (Field Trial)

Corn seeds were planted in an area of 28 m² by treatment with pneumatic machine at a depth of 3-5 cm, and later when the plants had 6 to 7 leaves the filtered culture medium produced by Alternaria alternata (obtained as described above in method 2) was applied in the form of spray at a concentration of 700L/ha (treatment 1) and 350L/ha (treatment 2). Eight months after planting all the grain was harvested. An increase between 1-8% in the amount of soluble protein in grain was observed in treatment 2. The results showed no significant changes in starch content.

### Examples 1.13-1.37

| | | | Target plant/ | Application | |
|---|---|---|---|---|---|
| | | | experiment | mode/ | |
| Ex. | Microorg. | Method | type | frequency | Parameter analysed |
| 1.13 | Alternaria alternata | Variation of | Corn/ | Foliar Spray/ | Biomass (2 times increase) |
| | CECT 20912 | method 1 | Field | Once | no shoots per plant (41% increase); |
| | | | | | no ears/plant (1.9 times increase); |
| | | | | | Ears fw/plant (48% increase); |
| | | | | | Seeds FW/plant (60% increase) |
| | | | | | Seeds DW/plant (52% increase) |
| 1.14 | Alternaria alternata | Variation of | Corn/ | Seed | Emergence + abiotic stress |
| | CECT 20912 | method 1 | Automatized | soaking | resistance. Under normal |
| | | | platform | before | conditions: Treated seeds |
| | | | | sowing in | germinated 1-2 days before non- |
| | | | | soil/Once | treated seeds; under stress |
| | | | | | conditions: Treated seeds |
| | | | | | germinate 1-2 days before non- |
| | | | | | treated seeds (emergence time of |
| | | | | | treated seeds similar to non-treated |
| | | | | | seeds in normal conditions) |
| 1.15 | Alternaria alternata | Method 10 | Tomato/ | Irrigation/ | 200% increase of No Half ripe fruits |
| | CECT 20912 | | Greenhouse | Twice | at harvest (week 21) |
| | | | 24° C.; 80% RH | | |
| 1.16 | Alternaria alternata | Method 6 | Tomato/ | Irrigation/ | 6.8% increase of Chlorophyll at |
| | CECT 20912 | | Greenhouse | Twice | week 8; 157% increase No Red |
| | | | 24° C.; · 80% RH | | Fruits per week (week 17); No |
| | | | | | Green Fruits per week (week 13) |
| | | | | | (45% increase); 22% increase in |
| | | | | | Total number of Red fruits |
| 1.17 | Alternaria alternata | Method 7 | Tomato/ | Irrigation/ | 109% increase of Weight Red fruits |
| | CECT 20912 | | Greenhouse | Twice | per 2 weeks (week 17-18) |
| | | | 24° C.; 80% RH | | 60% increase in weight per fruit per |
| | | | | | week (week 17) |
| 1.18 | Alternaria alternata | Variation of | Tomato/ | Irrigation | 17% Increase of Chlorophyll at |
| | CECT 20912 | Method 1 + | Greenhouse | with | week 9; 40.5% increase in the No |
| | | distillation | 24° C.; 80% RH | distillate/ | of Green Fruits per week (week 13) |
| | | (method 8) | | Twice | |
| 1.19 | Alternaria alternata | Variation of | Tomato/ | Irrigation | 11.7% Increase of Chlorophyll at |
| | CECT 20912 | Method 1 + | Greenhouse | with | week 9; 85% of increase in the No |
| | | distillation | 24° C.; 80% RH | concentrate/ | Red fruits per 2 weeks and 95% of |
| | | (method 8) | | Twice | increase of Weight Red fruits per 2 |
| | | | | | weeks (week 17-18); 256% of |
| | | | | | increase in weight Red Fruits per |
| | | | | | week (week 17) |
| 1.20 | Escherichia coli | Variation of | Tomato/ | Seed/Once | 22.6% increase in shoot Length |
| | BW25113 | method 11 | Growth | | 12.4% increase in Root length |
| | CGSC 7636 | | chamber | | |
| 1.21 | Escherichia coli | Variation of | Tomato/ | Irrigation/ | Decrease of 0.08 pH units without |
| | BW25113 | method 11 | Field | Twice | significant changes of ° Brix content |
| | CGSC 7636 | | | | |
| 1.22 | Escherichia coli | Variation of | Corn/ | Foliar spray/ | increase of total (18.5%) and |
| | BW25113 | method 11 | Field | Once | soluble (10%) protein content |
| | CGSC 7636 | | | | |
| 1.23 | Penicillium | Variation of | Tomato/ | Irrigation/ | 1.6% increase in Fruit firmness |
| | aurantiogriseum | method 1 | Field | Twice | |
| | CECT 20226 | | | | |
| 1.24 | Penicillium | Variation of | Corn/ | Seed | Emergence + abiotic stress |
| | aurantiogriseum | method 1 | Automatized | soaking | resistance; Under normal |
| | CECT 20226 | | platform | before | conditions: Treated seeds |
| | | | | sowing in | germinate 1-2 days before non- |
| | | | | soil/Once | treated seeds; under stress |
| | | | | | conditions: Treated seeds |
| | | | | | germinate 1-2 days before non- |
| | | | | | treated seeds (emergence time of |
| | | | | | treated seeds similar to non-treated |
| | | | | | seeds in normal conditions) |
| 1.25 | Penicillium | Method 7 | Tomato/ | Irrigation/ | |
| | aurantiogriseum | | Greenhouse | Twice | |
| | CECT 20226 | | | | |
| 1.26 | Penicillium | Method 9 | Pepper/ | Irrigation | 130% Yield increase, 82% increase |
| | aurantiogriseum | | greenhouse | with filtrate | in Number of fruits per plant; 27% |
| | CECT 20226 | | 18-25° C., 65% | 6 treatments | increase in fruit specific weight |
| | | | RH | | |
| 1.27 | Penicillium | Method 9 | Pepper/ | Irrigation | 51% increase in Yield, 40% |
| | aurantiogriseum | | Greenhouse | with distilled | increase in Number of fruits per |
| | CECT 20226 | | 18-25° C., 65% | 6 treatments | plant |
| | | | RH | | |
| 1.28 | Penicillium | Method 9 | Tomato/ | Irrigation | 11.5% increase in commercial |
| | aurantiogriseum | | open field | with filtered | Yield, 4.3% increase texture of |
| | CECT 20226 | | | 2 treatments | fruit, 9.3% increase in ° Brix, 4.2% |
| | | | | | increase in fruit specific weight; |
| | | | | | 4.1% increase in lenght of fruit |
| 1.29 | Penicillium | Variation of | Tomato/ | Seed/once | 35% increase in Aereal part FW |
| | chrysogenum | method 1 | In vitro | | 24% increase in Root FW |
| | CECT 2277 | | | | 15.5% increase in shoot length |
| 1.30 | Penicillium | Variation of | Corn/ | Foliar | 18.5% increase of total protein |
| | chrysogenum | method 1 | Field | Spray/once | content |
| | CECT 2277 | | | | |
| 1.31 | Penicillium | Method 9 | Pepper/ | Irrigation | 57% increase in Yield; 51% |
| | chrysogenum | | Greenhouse | with distilled/ | increase in number of fruits |
| | CECT 2277 | | 18-25° C., 65% | 6 treatments | |
| | | | RH | | |
| 1.32 | Penicillium | Method 9 | Pepper/ | Irrigation | Early plant growth, early Flower |
| | chrysogenum | | Greenhouse | with filtered/ | development; 40% increase in Fruit |
| | CECT 2277 | | 18-25° C., 65% | 6 treatments | specific weight; 134% increase in |
| | | | RH | | Yield, 67% increase in number of |
| | | | | | fruits per plant |
| 1.33 | Fusarium | Method 9 | Pepper/ | Irrigation | 82.5% Yield increase; |
| | oxysporum | | Greenhouse | with distilled/ | 64% increase in number of |
| | CECT 20420 | | 18-25° C., 65% | 6 treatments | commercial fruits per plant |
| | | | RH | | |
| 1.34 | Fusarium | Method 9 | Pepper/ | Irrigation | 80% Yield increase; |
| | oxysporum | | Greenhouse | with filtrate/ | 59% increase in number of |
| | CECT 20420 | | 18-25° C., 65% | 6 treatments | commercial fruits per plant |
| | | | RH | | |
| 1.35 | Trichoderma | Method 9 | Pepper/ | Irrigation | Early plant growth, early Flower |
| | harzianum | | Greenhouse | with filtered/ | development, 154% increase in |
| | CECT 2413 | | 18-25° C., 65% | 6 treatments | Yield; 93% increase number of |
| | | | RH | | fruits per plant; 31% increase in |
| | | | | | fruit specific weight |
| 1.36 | Trichoderma | Method 9 | Pepper/ | Irrigation | early Flower development, 60% |
| | harzianum | | Greenhouse | with distilled/ | increase in Yield, 63% increase in |
| | CECT 2413 | | 18-25° C., 65% | 6 treatments | number of commercial fruits per |
| | | | RH | | plant |
| 1.37 | B. aclada | Variation of | Tomato/ | Seed/once | 11.9% increase in shoot FW |
| | CECT 2851 | method 1 | In vitro | | 6.9% in root DW |

### Example 2. Effects of VOCs Emitted by Diverse Microorganisms Cultured on the Proximity of a Plant but Without Contacting It

Plant and Microbial Cultures and Growth Conditions

In this example the following plants were used: A. thaliana (Heynh), maize (Zea mays, cv. Hill), and pepper (Capsicum annuum, cv. Sweet Italian) plants.

The microorganisms used in this study were the following:

Fungi: Alternaria alternata (CECT 20912), Aspergillus awamori (CECT 2907), Aspergillus brasiliensis (CECT 2091), Beauveria bassiana (CECT 2704), Botrytis aclada (CECT 2851), Colletotrichum gloeosporioides (CECT 20249), Fusarium oxysporum (CECT 20420), Ophiostoma ips (CECT 20676), Paecilomyces clavisporus (CECT 20454), Penicillium chrysogenum (CECT 2277), Penicillium digitatum (CECT 20796), Penicillium aurantiogriseum (CECT 20226), Pichia fermentans var. fermentans (CECT 10064), Trichoderma harzianum (CECT 2413), Verticillium dahliae (CECT 2694), Wickerhamomyces anomalus (CECT 1114)

Bacteria: Bacillus amyloliquefaciens (CECT 493), Bacillus licheniformis (CECT 20), Bacillus pumilus (CECT 29), Burkholderia cepacia (CECT 322), Corynebacterium flavescens (CECT 536), Ensifer fredii (CECT 4369), Escherichia coli BW25113 (Keio collection (Baba et al., 2006)), Pseudomonas fluorescens (CECT 378), Serratia liquefaciens (CECT 483), Serratia odorifera (CECT 867), Stenotrophomonas maltophilia (CECT 7853).

Unless otherwise indicated Arabidopsis plants were cultured in Petri dishes containing sucrose-free solid MS (Duchefa Biochemie M0222) medium in growth chambers with a 16 h light (90 μmol photons sec-1 m-2)/8 h dark photoperiod (22° C. during the light period and 18° C. during the dark period). Bacteria were cultured in Petri dishes containing solid M9 minimal (95 mM Na₂HPO₄/44 mM KH₂PO₄/17 mM NaCl/37 mM NH₄O1/0.1 mM CaCl₂/2 mM MgSO₄, 1.5% bacteriological agar) medium supplemented with 50 mM glucose. M9 medium for B. subtilis culture was 1 supplemented with 7 μM each of MnSO₄, FeSO₄ and ZnSO₄, and 1 μM thiamine. Fungi were cultured in Petri dishes containing solid MS medium supplemented with 90 mM sucrose.

To investigate effects of microbial VOCs on Arabidopsis plants cultured in MS medium, microbial and plant cultures without lids were placed without physical contact into sterile plastic boxes (IT200N Instrument Try 200×150×50 mm, AWGregory, UK) and sealed with a plastic film. Effects of microbial VOCs on plants cultured on soil was investigated by placing microbial cultures without lids and plants in sealed mini-green houses. As negative control, plants were cultured together with adjacent Petri dishes containing sterile microbial culture media. Unless otherwise indicated microbial VOCs treatment started at the 14 days after sowing (DAS) growth stage of plants.

Arabidopsis plants were cultured on sucrose-free solid MS medium in the absence or continuous presence of adjacent cultures of phylogenetically diverse strains of beneficial and non-beneficial fungi and bacteria. These experiments were conducted in sterile growth boxes with no physical contact between the plant and the microbial cultures. VOCs emitted by all the tested microorganisms (including plant pathogens) induced 2- to 5-fold increases in fresh weight (FVV) of the Arabidopsis plants, relative to controls (FIG. 6a). VOCs from most of microorganisms also induced early flowering (FIG. 6b). In FIGS. 6a and 6b values represent the means ±SE determined from four independent experiments using 12 plants in each experiment. Asterisks indicate significant differences between microbial VOCs-treated plants and controls (non-treated plants) according to Student's t-tests (p<0.05).

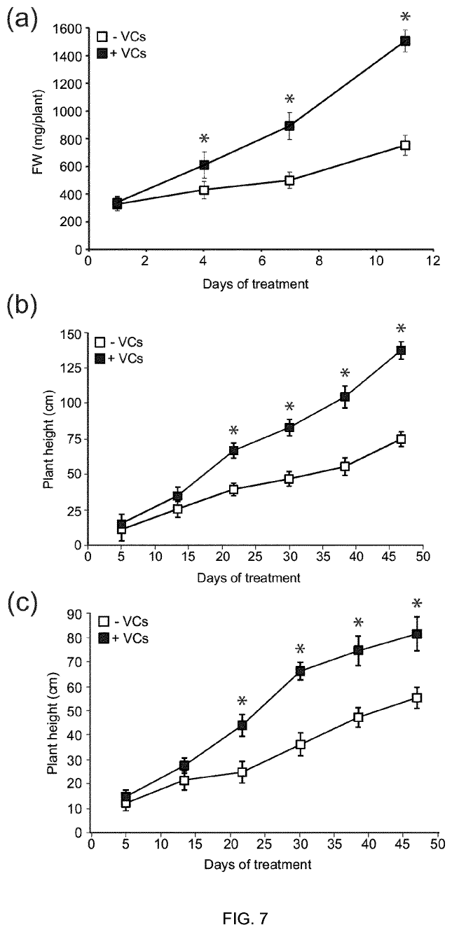

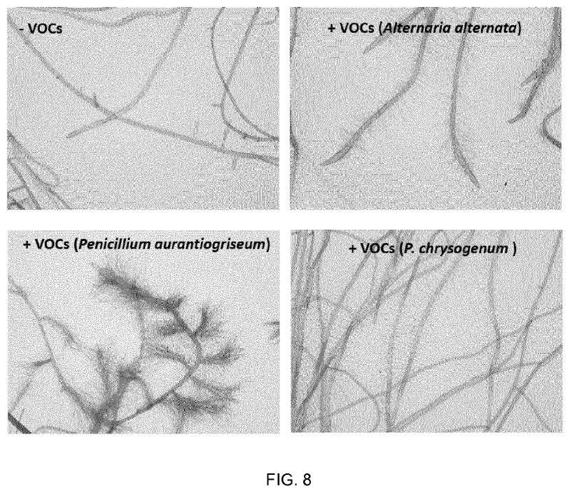

The response of microbial VOCs in soil-grown Arabidopsis, sweet pepper and maize plants was also assessed. The microbial VOCs-exposed Arabidopsis plants had significantly higher FW than controls within 4 days of the treatment, and twice as high FW after another seven days (FIG. 7a). In addition, exposed maize and pepper plants were almost twice as tall as controls from day 22 of the treatment until the end of experiment on day 47 (FIG. 7b,c). FIG. 7 shows the results for A. alternata but essentially the same results were obtained using cultures from other bacterial and fungal species (not shown). In FIG. 7 values represent the means ±SE determined from four independent experiments using 12 plants in each experiment. Asterisks indicate significant differences between VOCs-treated and non-treated plants according to Student's t-tests (p<0.05).

Root Architecture Determinations

Roots from 21 day old Arabidopsis plants subjected to fungal volatiles from Alternaria alternata, Penicillium aurantiogriseum and Penicillium chrysogenum for 7 days were microphotographed with a stereomicroscope Olympus MVX10 (Japan). Microphotographs were captured with an Olympus DP72video camera and Cell D software (Olympus) with 1.25× zoom. FIG. 8.

### Examples 2.1-2.2

Similarly to example 2 but following the method below, examples 2.1-2.2 were performed: 6 small pieces of mycelium (one week old) were inoculated in solid MS medium supplemented with 90 mM sucrose and allowed to grow at 30° C. for a week.

| | | Target plant/ | Application | |
|---|---|---|---|---|
| | | experiment | mode/ | |
| Ex. | Microorg. | type | frequency | Parameter analysed |
| 2.2 | Alternaria alternata | Arabidopsis/ | in vitro growth/ | 84% Increase of total free amino-acid |
| | CECT 20912 | in vitro | continuous | content; Increase in glucose (296%) and |
| | | | | fructose (229%) contents, decrease in |
| | | | | sucrose content (26%) (Measurements in |
| | | | | leaves) |
| 2.3 | Penicillium | Arabidopsis/ | in vitro growth/ | Increase of total free amino-acid content |
| | aurantiogriseum | in vitro | continuous | (50%); Increase in glucose (299%) and |
| | CECT 20226 | | | fructose (561%) contents, Decrease in |
| | | | | sucrose contents (18%) (Measurements |
| | | | | in leaves) |

### REFERENCES CITED IN THE APPLICATION

Ryu et al., “Bacterial volatiles promote growth in Arabidopsis”, Proceedings of the National Academy of Sciences of the United States of America 2003, 100(8), 4927-4932.

WO2011135121

Sambrook, J. and Russell, D. W. “Molecular Cloning: A Laboratory Manual”, Chapter 13, “Mutagenesis”, Cold Spring Harbor, 3rd Ed, 2001

1. A microorganism-free composition obtained by a method comprising the following steps:
(a) growing a microorganism in an appropriate culture medium; and
(b) removing the microorganism from the culture medium of step a) when the microorganism growth has started the logarithmic growth phase, to obtain the microorganism-free composition,
wherein the microorganism is selected from the group consisting of: strain CECT 20912 of Alternaria alternata or a mutant thereof, strain CECT 2662 of Alternaria alternata or a mutant thereof, strain CECT 20560 of Alternaria alternata or a mutant thereof, strain CECT 20923 of Alternaria alternata or a mutant thereof, strain CECT 20943 of Alternaria alternata or a mutant thereof, strain DSM-1102 of Alternaria alternata or a mutant thereof, strain DSM-12633 of Alternaria alternata or a mutant thereof, strain DSM-62006 of Alternaria alternata or a mutant thereof, strain DSM-62010 of Alternaria alternata or a mutant thereof, strain MTCC 1779 of Alternaria alternata or a mutant thereof, strain MTCC 3793 of Alternaria alternata or a mutant thereof, strain MTCC 6572 of Alternaria alternata or a mutant thereof, strain MTCC 7202 of Alternaria alternata or a mutant thereof, strain MTCC 7959 of Alternaria alternata or a mutant thereof, strain MTCC 8459 of Alternaria alternata or a mutant thereof, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, Penicillium charlesii, Aspergillus awamori, Aspergillus brasiliensis, Colletotrichum gloeosporioides, Ophiostoma ips, Paecilomyces clavisporus, Penicillium digitatum, Pichia fermentans var. fermentans, Saccharomyces cerevisiae, Verticillium dahliae, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Pseudomonas fluorescens, Pseudomonas syringae, Salmonella enterica, Serratia liquefaciens, Serratia odorifera, and Stenotrophomonas maltophilia.

2. The microorganism-free composition according to claim 1, wherein the microorganism is selected from the group consisting of: strain CECT 20912 of Alternaria alternata or a mutant thereof, strain CECT 2662 of Alternaria alternata or a mutant thereof, strain CECT 20560 of Alternaria alternata or a mutant thereof, strain CECT 20923 of Alternaria alternata or a mutant thereof, strain CECT 20943 of Alternaria alternata or a mutant thereof, strain DSM-1102 of Alternaria alternata or a mutant thereof, strain DSM-12633 of Alternaria alternata or a mutant thereof, strain DSM-62006 of Alternaria alternata or a mutant thereof, strain DSM-62010 of Alternaria alternata or a mutant thereof, strain MTCC 1779 of Alternaria alternata or a mutant thereof, strain MTCC 3793 of Alternaria alternata or a mutant thereof, strain MTCC 6572 of Alternaria alternata or a mutant thereof, strain MTCC 7202 of Alternaria alternata or a mutant thereof, strain MTCC 7959 of Alternaria alternata or a mutant thereof, strain MTCC 8459 of Alternaria alternata or a mutant thereof, Penicillium aurantiogriseum, Escherichia coli, Penicillium chrysogenum, Fusarium oxysporum, Wickerhamomyces anomalus, Botrytis aclada, Trichoderma harzianum, Beauveria bassiana, and Penicillium charlesii.

3. The microorganism-free composition according to claim 2, wherein the microorganism is selected from the group consisting of: strain CECT 20912 of Alternaria alternata or a mutant thereof, strain CECT 20226 of Penicillium aurantiogriseum or a mutant thereof, strain 2277 of Penicillium chrysogenum or a mutant thereof, strain CGSC 7636 of Escherichia coli BW25113 or a mutant thereof, strain CECT 20420 of Fusarium oxysporum or a mutant thereof, strain CECT 2413 of Trichoderma harzianum or a mutant thereof, and strain CECT 2851 of Botrytis aclada or a mutant thereof.

4. A composition comprising an inactivated microorganism obtained by a method comprising the following steps:
(a) growing a microorganism cell culture in an appropriate medium; and
(b) inactivating the microorganism in the culture medium of step a) when the microorganism growth has started the logarithmic growth phase, to obtain the composition comprising an inactivated microorganism, wherein the microorganism is selected from the species consisting of Alternaria alternata, Aspergillus awamori, Aspergillus brasiliensis, Beauveria bassiana, Botrytis aclada, Colletotrichum gloeosporioides, Fusarium oxysporum, Ophiostoma ips, Paecilomyces clavisporus, Penicillium charlesii, Penicillium chrysogenum, Penicillium digitatum, Penicillium aurantiogriseum, Pichia fermentans var. fermentans, Saccharomyces cerevisiae, Trichoderma harzianum, Verticillium dahliae, Wickerhamomyces anomalus, Agrobacterium tumefaciens, Bacillus amyloliquefaciens, Bacillus licheniformis, Bacillus pumilus, Bacillus subtilis, Burkholderia cepacia, Corynebacterium flavescens, Ensifer fredii, Escherichia coli, Pseudomonas fluorescens, Pseudomonas syringae, Salmonella enterica, Serratia liquefaciens, Serratia odorifera, and Stenotrophomonas maltophilia.

5. The composition comprising an inactivated microorganism according to claim 4, wherein the microorganism is selected from the group consisting of: strain CECT 20912 of Alternaria alternata or a mutant thereof, and strain CECT 20226 of Penicillium aurantiogriseum or a mutant thereof.

6. An agricultural composition comprising the microorganism-free composition as defined in claim 1, together with one or more agriculturally acceptable carriers.

7. A method for obtaining a microorganism-free composition as defined in claim 1, which comprises the following steps:
(a) growing a microorganism in an appropriate culture medium; and
(b) removing the microorganism from the microorganism culture medium of step a) when the microorganism growth has started the logarithmic growth phase, to obtain the microorganism-free composition.

8. The method according to claim 7, wherein step b) is performed by centrifugation and/or filtration.

9. A method for obtaining a composition comprising an inactivated microorganism as defined in claim 4, which comprises the following steps:
(a) growing a microorganism cell culture in an appropriate medium; and
(b) inactivating the microorganism in the culture medium of step a) when the microorganism growth has started the logarithmic growth phase, to obtain the composition comprising an inactivated microorganism.

10. The method according to claim 7, wherein step b) is carried out when the colony forming units (CFU) per milliliter is equal or higher to 10³.

11. The method according to claim 7, wherein the culture medium of step a) is lacking amino acids and/or proteins.

12. The method according to claim 7, wherein the culture medium of step a) is selected form the group consisting of M9, MOPS, and MS, optionally supplemented with vitamins.

13. The method according to claim 7, wherein the culture medium of step a) further comprises an organic compound as carbon source selected from the group consisting of: sucrose, glucose, succinate, starch, fructose, maltose, maltotriose, lactose, galactose, and xylose.

14-15. (canceled)

16. A method for promoting stimulatory activity on a plant comprising administering to the plant an effective amount of a composition as defined in claim 1.

17. An agricultural composition comprising an inactivated microorganism as defined in claim 4, together with one or more agriculturally acceptable carriers.

18. A method for promoting stimulatory activity on a plant comprising administering to the plant an effective amount of a composition as defined in claim 4.

19. The method according to claim 9, wherein step b) is carried out when the colony forming units (CFU) per milliliter is equal or higher to 10³.

20. The method according to claim 9, wherein the culture medium of step a) is lacking amino acids and/or proteins.

21. The method according to claim 9, wherein the culture medium of step a) is selected form the group consisting of M9, MOPS, and MS, optionally supplemented with vitamins.

22. The method according to claim 9, wherein the culture medium of step a) further comprises an organic compound as carbon source selected from the group consisting of: sucrose, glucose, succinate, starch, fructose, maltose, maltotriose, lactose, galactose, and xylose.
